(19) United States
(12) Patent Application Publication
(10) Pub. No.: US 2009/0268732 A1
(43) Pub. Date: Oct. 29, 2009

(54) Channel change tracking metric in multicast groups

(75) Inventors: Tomas A. Cernius, Beverly Shores, IN (US); Aaron Michael Smith, Noblesville, IN (US)

Correspondence Address: Thomson Licensing LLC, P.O. Box 5312, Two Independence Way, PRINCETON, NJ, 08543-5312, US

(73) Assignee: THOMSON LICENCING

(21) Appl. No.: 12/150,480

(22) Filed: Apr. 29, 2008

(51) Int. Cl. H04L 12/56

(52) U.S. Cl. 370/390

(57) ABSTRACT

A method, device and computer readable medium that measures the error rate in a network data stream to a device, for example a Set Top Box. The method including joining one or more multicast groups representing audio and or video data for a requested channel; discarding a predetermined number of received packets for each of the joined multicast groups; and comparing a sequence number of a first packet received subsequent to the predetermined number of discarded packets to a sequence number of a next subsequent received packet in order to determine a sequence error. The method may further include tracking sequence numbers of received packets for one or more of the joined multicast groups; incrementing a packets received counter for each received packet for one or more of the joined multicast groups; and comparing each received sequence number with the next received sequence number in order to determine sequence errors.

### FIELD OF THE INVENTION

The present invention is generally related to improvements in measuring error rates in a multicast nodal system. More particularly, the present invention pertains to a method and system for measuring and keeping track of the packet sequence error rate across all currently joined multicast streams.

### BACKGROUND OF THE INVENTION

The internet uses an internet protocol (IP) to effect communication amongst a variety of hardware and software devices spread throughout its structure. Each one of these hardware and software devices can be considered nodal points or nodes in the network. Different nodes communicate across the network using the IP protocol but may also utilize supplementary protocols depending upon the implementation used. For example, some multicast groups utilize the Internet Group Management Protocol (IGMP) and Real-time Transport Protocol (RTP) protocols to effect different functionalities. The nodal points or IP hosts use IGMP to register their dynamic multicast group membership. Additionally, routers use this same protocol to discover these group members. The RTP protocol is used in the delivery and control of real time sensitive information, for example audio and video data. In particular, RTP is a standardized packet protocol that delivers audio and video data over the internet.

The RTP is useful in a system as shown in FIG. 1, and is useful in explaining the present invention. As shown in FIG. 1, a satellite transmits on a transponder at a predetermined frequency such as a frequency of 103 Mhz or some other generic frequency. A tuner gateway (Transponder Receiving System 102) tunes to the satellite transponder frequency when requested to by an IP Set Top Box (IPSTB) 100. Typically the IPSTB 100 is separated from the Transponder Receiving System 102 by an IP network 101. In some arrangements of such a system Mpeg Transport Streams are transmitted from the satellite to the satellite receiving system. The satellite receiving system encapsulates the stream into RTP that is forwarded to the IPSTB.

One of the implementations of the RTP protocol requests data across the internet. For Example, using RTSP Real-time Streaming Protocol the IPSTB 100 may request the Transponder Receiving System 102 to tune to a frequency and deliver data to the IPSTB 100. One such request may be a channel change request which may result in multiple actions occurring including intervening steps which include the IGMP join and RTP transmission and reception. The IGMP join to multicast groups causes a node to join a particular group as well as registration of that fact. Another example is the reception of the audio and or video data transmitted according to the RTP protocol back to the IPSTB.

Thus, conventional digital satellite channel change requests result in a simple command from a requesting node to a tuner/transponder to tune to a given frequency. Once this request is received at the tuner/transponder a command is issued to start data delivery downstream. As a result, digital audio and or video data starts to flow to the requesting node, which as pointed out above can be an Internet Protocol Set Top Box or IPSTB.

However, all of these fail to keep track of the overall packet sequence error rate across all currently joined multicast streams. Accordingly, there is a need to overcome the deficiencies of the prior art as described above.

### SUMMARY OF THE INVENTION

In one embodiment a device for measuring an error rate in a network data stream includes a processing unit for joining one or more multicast groups representing one or more data streams, discarding a predetermined number of received packets for each of the joined multicast groups; and comparing a sequence number of a first packet received subsequent to the predetermined number of discarded packets to a sequence number of a next subsequent received packet in order to determine a sequence error; and a memory storing addresses of the joined one or more multicast groups and a sequence number of a last received packet.

In another embodiment a method includes joining one or more multicast groups representing audio and or video data for a requested channel; discarding a predetermined number of received packets for each of the joined multicast groups; and comparing a sequence number of a first packet received subsequent to the predetermined number of discarded packets to a sequence number of a next subsequent received packet in order to determine a sequence error.

### BRIEF DESCRIPTION OF THE FIGURES

The subject matter that is regarded as the invention is particularly pointed out and distinctly claimed in the claims at the conclusion of the specification. The foregoing and other objects, features and advantages of the invention will be apparent from the following detailed description taken in conjunction with the accompanying drawings.

FIG. 1 is an illustration of the generalized IP Set Top Box IPSTB transponder network system within which the invention may be utilized.

FIG. 2 is an illustration of a multicast table (MCAST TABLE) that is utilized by the instant invention for multicast data packets and their associated data entries.

FIG. 3 is an illustration of a method that is utilized by the instant invention to change and or join multicast audio and or video and or generic data streams.

FIG. 4 is an illustration of a method that is utilized by the instant invention to keep track of the error rate for all the multicast data streams using a global error counter.

### DETAILED DESCRIPTION OF THE PREFERRED EMBODIMENTS

It is important to note that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality.

In the drawings, like numerals refer to like parts through several views.

### 1. IP Set Top Box Transponder System

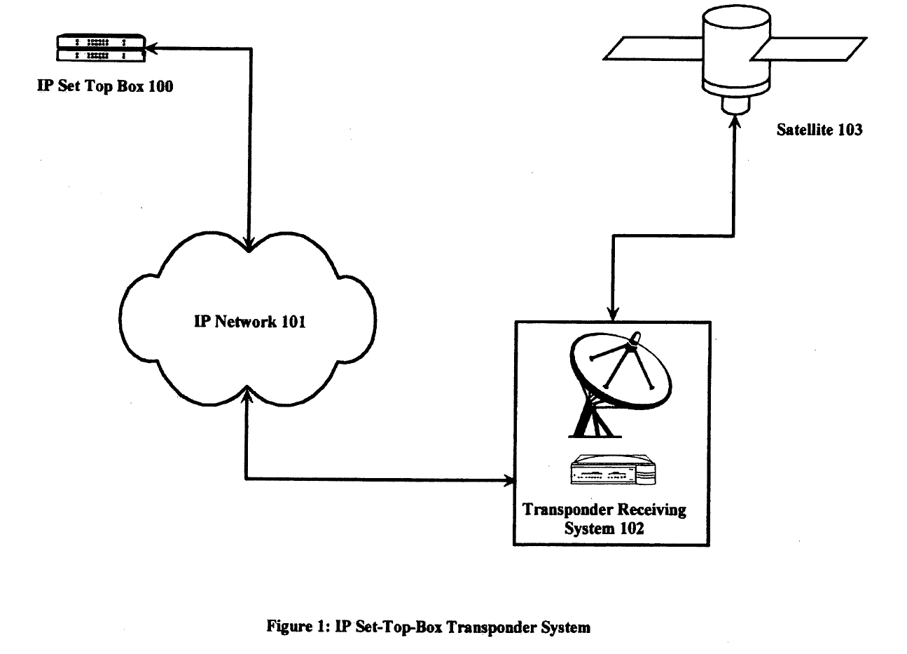

FIG. 1 is an illustration of the generalized IP Set Top Box IPSTB transponder network system within which the invention may be utilized. The IPSTB Transponder System is comprised of several main components including but not limited to: one and or more IP Set Top Boxes 100 IPSTBs, a generalized communications network 101, a transponder receiving system 102 and a satellite 103.

The IPSTB 100 is an electronic device made of a combination of hardware, and or firmware and or software. It comprises one or more processing units, memories, data and or control buses, power supplies amongst many other components. The IPSTB 100 acts as an interface between an audio and or video terminal and a high bandwidth network. It has the ability to decode broadcast video signals as well as presenting or rendering these signals. Further, the IPSTB is capable of supporting a variety of user interactive and multimedia functionalities. Amongst these are the services of electronic programming guide, digital rights management and video on demand. Further, The IPSTB 100 can provide one and or more of the following services including but not limited to: home networking, gateway functionality, web browsing, voice-over-IP, email, email attachment visualization, computer connectivity and advanced codecs used in multimedia, and other television functionalities. The IPSTB is most generally thought of as a ‘black box’ of hardware, software and or firmware using a generic protocol so that the IP is generalized to a generic communications protocol.

IP network 101 is most broadly a generalized computer network that has many implementations including but not limited to: a wide area network (WAN), a local area network (LAN), an Appletalk network, the internet or world wide web, an Ethernet network, an IP network and or a generalized computer network. This network comprises a variety of different other hardware, software and or firmware components including but not limited to: routers, repeaters, power supplies, software protocol translators and or many other generic components all arranged in a plurality of different manners. The inclusion of some components is not meant to be limiting. Additionally, whilst an IP protocol is specifically described other protocols may be used in substitution of the IP protocol such that a generic protocol is utilized to communicate from the generalized black box 100 to the satellite 103.

Next, transponder receiving system 102 comprises one or more local processing units, memories, a satellite transponder system that enables communication with satellite 103 amongst many other components. The transponder receiving system 102 is in communication with both satellite 103 and with IPSTB 100 across network 101 from which it receives tuning requests. These requests are forwarded on to satellite 103 that receives them and transmits replies via its onboard transponder. The subsequent replies are forwarded to earth-based transponder receiving system 102 across the generalized computer network 101 and back to the IPSTB 100. The aforementioned satellite 103 comprises a processing unit and transponder system both of which are not shown in the drawings amongst many other components.

### 2. MCAST TABLE

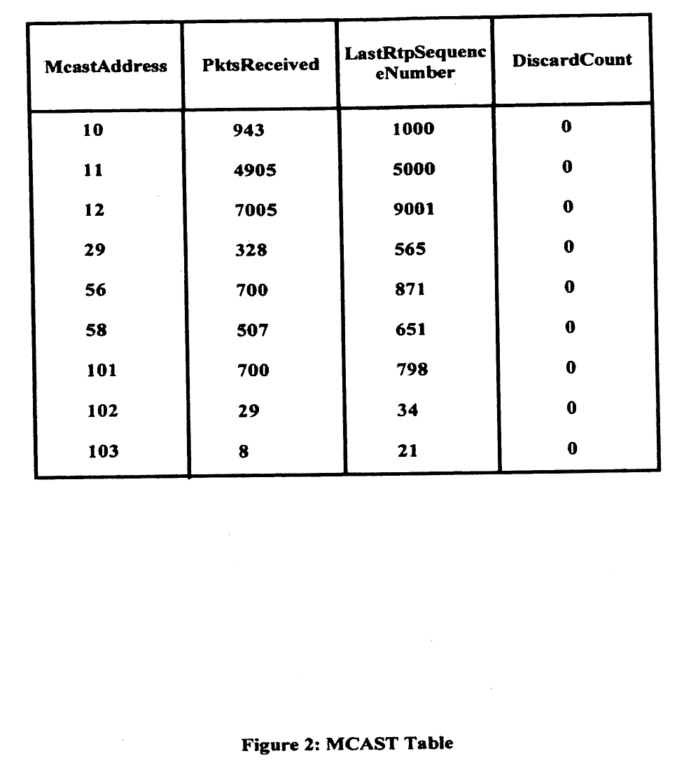

FIG. 2 is an illustration of a multicast table better known as a MCAST TABLE. This table is utilized by the instant invention for multicast data packets and their associated data entries. The table is stored in one or more IPSTBs and may be read from and written to memories of the IPSTB by onboard processing unit(s). The specific data present in the table shown in FIG. 2 are representative data only and are intended for illustrative purposes only. Thus, the specific data shown are not intended to be exclusive of the many data items that are found in a variety of implementations of the instant invention.

The MCAST TABLE comprises four main entry categories that describe different sets of data. These categories are namely:
1—an McastAddress category;
2—a PktsReceived category;
3—a LastRtpSequenceNumber category; and
4—a DiscardCount category.
   Each of these entries represent different data items that are now to be described below.

2.1 McastAddress

This represents the address of a unique multicast channel data stream group and or groups. For example, when a request is made to join or enter a news or other information stream channel, there is a multicast group for the video and there is another one for the audio; additionally, if the news sources comprises a stock ticker there is another group for the stock ticker information. Of course the many data streams comprising the one channel data stream are capable of being organized in any different combination of the aforementioned. For example, the stock ticker and video may be sent as one multicast group and the audio is another multicast group; or the stock ticker and audio in one group and the video in another group; or the audio and video in one group and the stock ticker in another group. Further, a single multicast group is also contemplated representing all of the audio, video and stock ticker information combined as one multicast group. As another example, consider the FM, AM and other satellite radio stations that are sent via these systems representing a single audio group. Thus, the invention most broadly comprises one and or more generic multicast groups carrying one and or more different types of generic data to the IPSTB and the final end user.

Finally, it should be noted that in general Mcast addresses are of the form 239.255.255.255 thru 224.0.0.0. The Internet Assigned Numbers Authority (IANA) controls the assignment of IP multicast addresses and has assigned the old Class D address space to be used for IP multicast. This means that all IP multicast group addresses will fall in the range of 224.0.0.0 to 239.255.255.255. Of course this is an example of a specific embodiment and in some other more generic systems this may not be the case. Thus, the invention most broadly contemplates using any form of addressing scheme in the McastAddress table entry and is not limited to using the aforementioned IP multicast addressing format. For example, the McastAddresses shown in the table of FIG. 2 are generic numbers representing addresses 10, 11, 12, 29, 56, 58, 101, 102 and 103 and the invention may utilize any other type of alphanumeric addressing format.

2.2 PktsReceived

Next, the invention utilizes a PktsReceived entry to provide a count of the number of packets received through a particular McastAddress. The count is incremented once an incoming packet has arrived and is written to the table of FIG. 2 which may be stored in the IPSTB 100.

2.3 LastRtpSequenceNumber

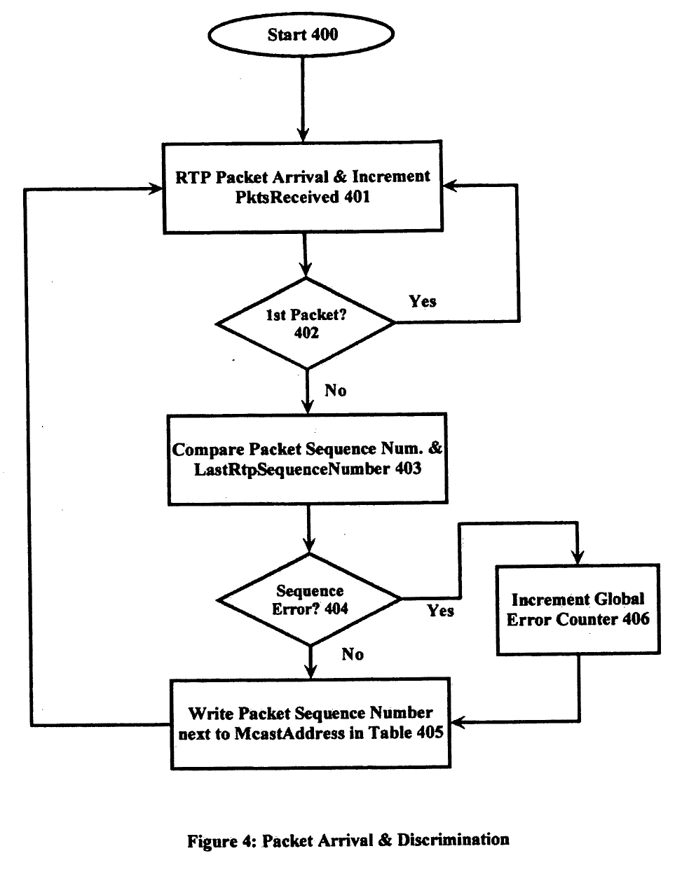

This number represent the last sequence number of an approved packet that has been previously entered into the MCAST TABLE. The process proceeds as in this following example. Turning to the fourth row of FIG. 2 one finds PktsReceived representing 328 packets received so far as shown in the MCAST TABLE and the LastRtpSequenceNumber is 565; thus one would expect that the next sequence number should be 566. However, upon inspecting the incoming packet it is found that the incoming packet sequence number is 573. The IPSTB processing unit and or controller would increment the PktsReceived to 329 and write the same into its registers and or memories associated with IPSTB 100. Further, the LastRtpSequenceNumber is raised to 573 since the incoming sequence number has now become the LastRtpSequenceNumber for the subsequent packet. In this example, an error has been determined in that the expected sequence number 566 has not matched the incoming sequence number of 573. Thus, an error is registered through the use of a GLOBAL ERROR COUNTER to be described in connection with FIG. 4.

2.4 Discard Count

The discard counter DiscardCount is used to discard one or more packets during a channel change from an old set of one or more McastAddress groups to a new set of one or more McastAddress groups or from a null (zero) set to a new set that has been added to the table. Thus, during the transition from one channel to another (or from no channel to a new channel when the system is turned on) a predetermined number of packets (for example five) are discarded. In real-time the system normally receives anywhere from 300 to 2000 packets per second. So a discard rate of five packets is relatively fast in the overall scheme. It should be noted that the above number of discard packets and packet arrival rate are most broadly defined as any number of discard packets and any number of packets per second arriving that are dependent upon the implementation of the invention.

Thus, during discard mode the invention does not even look at the packet. On the contrary, it simply discards a predetermined number of incoming packets so as to avoid spurious data arriving as a result of the change. The general discard mode is described as follows. A user changes channels resulting in one and or more McastAddress(-es) being written into the MCAST TABLE. It should be noted that at this point in the channel change the LastRtpSequenceNumber has not yet being utilized. Rather it will be utilized as described elsewhere and in connection with the GLOBAL ERROR COUNTER of FIG. 4. As the first packets are arriving the invention simply discards a predetermined number of packets; for example, five packets for each McastAddress or group are discarded. The counter DiscardCount is written for each decrement or increment of each group into the memory and or processing unit register associated with the IPSTB 100. It is decremented from the predetermined number of packets to be discarded for each McastAddress or group until it reaches zero; alternatively, it can be incremented until the predetermined number of discard packets is reached.

Once the first packet after the predetermined number has arrived, the invention sets the LastRtpSequenceNumber to what is inside the packet. For example, if five packets are to be discarded then upon the arrival of the sixth packet, the invention sets the LastRtpSequenceNumber to what is inside the packet. Then the discard mode is exited and the system begins operating in its normal mode. As a result, the next incoming sequence number for each McastAddress should be one more than the LastRtpSequenceNumber written in the table for each Mcast address. The discard counter DiscardCount for each multicast address or group is an arbitrary number that is counted up or down; thus, it marks the number of packets being discarded at the start of a channel change for a particular implementation. In this example, a limit of five errors has been set for a given multicast group, however, a generic discard counter limit can be set to any number as desired in the broadest generalization of the invention.

Finally, it should be noted that the sequence number for one multicast address packet or packet from a particular group has no connection to the packet sequence number from any other multicast address or group. However, the sequence numbers from one packet to the succeeding packet within a multicast group or address is sequential and ordinarily incremented by one or some predetermined offset.

Thus, in an example embodiment, whenever a new McastAddress is added to the table shown in FIG. 2, the discard count is set to the default number, for example 5. As the packets begin to arrive (for the first time) they are discarded and the discard count is decremented. Once the DiscardCount hits zero, the system begins to accept the packets. So if PktsReceived is 5000, 10, or even 5, the DiscardCount will be 0.

### 3. Channel Change & MCAST Join

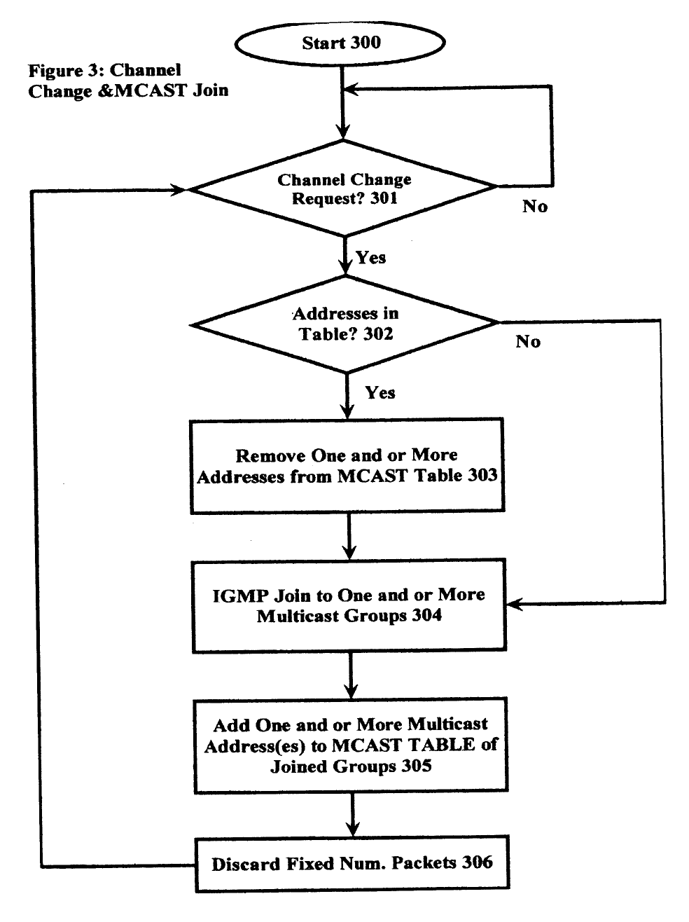

FIG. 3 is an illustration of a method that is utilized by the instant invention to change and or join multicast audio and or video and or generic data streams. The process starts at step 300 which simply represents the initialization procedure of the device. For example when the multicast IPSTB is turned on or when the video and or audio device receiver is connected to the IPSTB or when the video and or audio device are just turned on then this process starts. Then it is determined whether or not a user has requested a channel change 301, whether or not the audio and or video receiver has just been turned on, or whether or not the IPSTB has just been turned on or initialized. In the event of one of the foregoing not being true then the process loops back to step 301 until he or she requests a channel change or until the audio and or video receiver, and or IPSTB 100 are turned off.

Then the process flows to determining 302 if there are one and or more addresses representing multicast groups in the MCAST TABLE; this happens when a user issues a channel change request. If there are no addresses present in the MCAST TABLE then the method joins 304 the particular multicast groups represented by the channel change using IGMP and data begins to flow to the IPSTB 100 from the satellite 103 through transponder receiving system 102 and across the generalized network 101. The Internet Group Management Protocol is utilized to register the IPSTB joining of the group. Then the one and or more multicast addresses of the joined groups are added 305 to the MCAST TABLE by writing this data into, for example, memories and or registers of the one and or more processing units associated with IPSTB 100. At this point, a predetermined number of packets arriving from each group are discarded 306 as described below.

The discard counter DiscardCount is used to discard one or more packets during a channel change from an old set of one or more McastAddress groups to a new set of one or more McastAddress groups or from a null (zero) set to a new set that has been added to the table. Thus, during the transition from one channel to another (or from no channel to a new channel when the system is turned on) a predetermined number of packets (for example five) are discarded. In real-time the system normally receives anywhere from 300 to 2000 packets per second. So a discard rate of five packets is relatively fast in the overall scheme. It should be noted that the above number of discard packets and packet arrival rate are most broadly defined as any number of discard packets and any number of packets per second arriving that are dependent upon the implementation of the invention.

Thus, during discard mode the IPSTB or system does not even look at the packet. On the contrary, it simply discards a predetermined number of incoming packets so as to avoid spurious data arriving as a result of the change. The general discard mode is described as follows. A user changes channels resulting in one and or more McastAddress(-es) being written into the MCAST TABLE. It should be noted that at this point in the channel change the LastRtpSequenceNumber has not yet being utilized. Rather it will be utilized as described elsewhere and in connection with the GLOBAL ERROR COUNTER of FIG. 4. As the first packets are arriving a predetermined number of packets are simply discarded; for example, five packets for each McastAddress or group are discarded. The DiscardCount is written for each decrement or increment of each group into memory and or processing unit register associated with the IPSTB 100. It is decremented from the predetermined number of packets to be discarded for each McastAddress or group until it reaches zero; alternatively, it can be incremented until the predetermined number of discard packets is reached.

Once the first packet after the predetermined number has arrived, according to this embodiment, the LastRtpSequenceNumber is set to what is inside the packet. For example, if five packets are to be discarded then upon the arrival of the sixth packet, the LastRtpSequenceNumber is set to what is inside the packet. Then the discard mode is exited and the IPSTB begins operating in its normal mode. As a result, the next incoming sequence number for each McastAddress should be one more than the LastRtpSequenceNumber written in the table for each Mcast address. The discard counter DiscardCount for each multicast address or group is an arbitrary number that is counted up or down; thus, it marks the number of packets being discarded at the start of a channel change for a particular implementation. In this example, a limit of five errors has been set for a given multicast group, however, a generic discard counter limit can be set to any number as desired in the broadest generalization of the invention.

Turning back to step 302 of FIG. 3, in the event that it was determined that there were addresses found in the table, one and or more McastAddress(-es) and associated data from the MCAST TABLE are removed (block 303). Removing means, for example, overwriting the irrelevant data with a standard bit mask (or null data set) or the updating of the stored data to reflect this change by simply not using the particular memory locations anymore. If there was relevant data, in other words data useable by the new multicast group, then this old relevant data is not overwritten nor removed. This happens because a new channel is being requested and only old irrelevant channel data is being thrown out to make room for the new data. Then the method joins 304 the particular multicast groups represented by the channel change using IGMP and data begins to flow to the IPSTB 100 from the satellite 103 through transponder receiving system 102 and across the generalized network 101.

It should be noted that in the process of leaving an MCAST group, the associated RTP packets usually continue to flow as there are others watching this channel or “joined to this group,” i.e., watching the audio and or video stream. When a user switches to another channel, he or she leaves this group and joins another group. This leaving of the group may also cause his or her local network interface to block the reception of these packets at the lowest level so as not to bog down the processor wasting time on a non-requested data stream. Additionally, any network devices upstream from the IPSTB may use the “leave” to stop forwarding these RTP MCAST packets downstream if nobody downstream from it is watching a particular group or set of groups.

Returning to FIG. 3, the Internet Group Management Protocol is utilized to register the IPSTB joining of the group. Then the one and or more multicast addresses of the joined groups are added to the MCAST TABLE by writing this data into the one and or more volatile and or non-volatile memories and or registers of the one and or more processing unit associated with IPSTB 100. At this point, a predetermined number of packets arriving from each group are discarded step 306 as described previously in connection to the other branch from step 302 to step 304. It should be noted that the overall process loops continuously until one or more of the IPSTB, audio and or video receiver are turned off.

### 4. Packet Arrival & Discrimination

Next, FIG. 4 is an illustration of a method that is utilized by an embodiment of the present invention to keep track of the error rates of each multicast data stream. The process of Packet Arrival and Discrimination begins at step 400 that represents either a general initialization phase or simply a diagrammatic representation of the start of the process. In either case, RTP packets begin arriving 401 at the IPSTB 100 from the satellite 103 that has transmitted them across transponder receiving system 102 and generalized network 101. After each packet arrival, PktsReceived is incremented and updated in the MCAST TABLE for each joined group; thus, PktsReceived counts the number of packets being received. In the event that this is the first packet after the first predetermined number of discarded packets, then that first packet sequence number is written to the MCAST TABLE as the LastRtpSequenceNumber. Of course this is written for each and every one of the multicast groups that represent the particular selected channel. In the event that the incoming packet represents packets subsequent to the first packet after the predetermined number of discarded packets, then the routine enters into a comparison step but if it was the first packet after the discard the routine loops to step 401 because there is no sequence number to be compared.

Then step 403 compares the,current received packet's sequence number that has just been received across network 101 from satellite 103 and transponder receiving system 102 with the previously written sequence number (for example, stored in memories and or registers of the processing unit(s) associated with the IPSTB 100) known as the LastRtpSequenceNumber for each multicast group or address. Then a determination is made as to whether or not a sequence error 404 has been found in the current packet data stream. If a sequence error has been detected in the current received packet, then a GLOBAL ERROR COUNTER is incremented 406 and written to memory and or registers of a processor associated with IPSTB 100. Of course, the counter would have been initialized in the setup of the process. Then, the sequence number of the current packet is written 405 as the LastRtpSequenceNumber for the Mcast group that it represents in the MCAST TABLE memory and the process is the same for all of the addresses and groups that have been joined. The process loops back to the packet arrival step 401. The process is continuously running as long as data packets are being received across network 101 from transponder receiving system 102 and satellite 103. It should be noted that this process loops continuously until one or more of the IPSTB, audio and or video receiver are turned off.

In the event that determination step 404 finds that the sequence number of the currently received packet is indicative of a proper series then the process proceeds to step 405. There the sequence number of the current packet is entered or written to the memory or memories housing the MCAST Table next to its address group entry and the process loops back to the packet arrival step 401 and the process is the same for all of the addresses and groups that have been joined. The process is continuously running as long as data packets are being received across network 101 from transponder receiving system 102 and satellite 103. It should be noted that this process loops continuously until one or more of the IPSTB, audio and or video receiver are turned off.

### 5. GLOBAL ERROR COUNTER and Other Considerations

In a further embodiment of the present invention a Global Error Counter is implemented so that when an incoming multicast group sequence number does not match the previous number a Global Error Counter is incremented. This Global Error Counter provides a measure of the general health of that frequency/transponder/associated RTP stream. The Global Error Counter is presentable to the user in snapshots of real-time data in buttons, LEDs, LCDs, a plasma display, a CRT device or some other form of generic display device that indicates to a user, for example a maintenance technician, the ongoing status of the IPSTB 100. Further, snapshots of the data are downloadable as part of an IPSTB 100 diagnostic maintenance schedule. The GLOBAL ERROR COUNTER is most broadly a summation across all the joined groups or addresses that are joined on a particular channel using a one to one correspondence for each error.

For example, in the previous example above, an expected sequence number was 566 because the LastRtpSequenceNumber was 565. However, the incoming packet sequence number was found to be 573. This would represent errors in packets 566, 567, 568, 569, 570, 571 and 572. Thus, the total number of errors for the McastAddress 29 would be seven (7) errors. If these had been the only errors up to that point then the GLOBAL ERROR COUNTER would be incremented to seven errors. As each multicast address experiences packet errors, the GLOBAL ERROR COUNTER is incremented for a sum total across all of the data streams. In other words, the errors are commingled.

Alternatively, the GLOBAL ERROR COUNTER is broken down into one global counter for each and every multicast address. Further, in another implementation, the global counter, whether of the sum total variety or the each address variety, represents the errors not as a one to one correspondence with each and every packet error but that each consecutive set of packet errors are treated as one error. For the example dealing with errors in packets 566, 567, 568, 569, 570, 571 and 572, whilst there are seven (7) packets in error the sequence is considered one error and the GLOBAL ERROR COUNTER is incremented by one for each sequence of errors.

Finally, it should be noted that the sequence number for one multicast address packet or packet from a particular group has no connection to the packet sequence number from any other multicast address or group. However, the sequence numbers from one packet to the succeeding packet within a multicast group or address is sequential and ordinarily incremented by one or some predetermined offset.

### Discussion of Hardware and Software Implementation Options

The present invention, as would be known to one of ordinary skill in the art could be produced in hardware or software, or in a combination of hardware and software. The system, or method, according to the inventive principles as disclosed in connection with the preferred embodiment and other embodiments, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiment and other embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory, or may be on a transportable medium such as a disk, or a fixed disk, or a memory stick, or any other type of memory as known to those of ordinary skill in the art.

The invention is not limited to any particular computer program or logic or language instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, disk drive memory, CD-ROM, and other permanent storage. Additionally, a computer readable medium may include, for example, volatile storage, such as RAM, buffers, cache memory, and network circuits.

Further, the computer readable medium may include computer readable information in a transitory state medium such as a network link and /or a network interface, including a wired network or a wireless network, that allow a computer to read such computer readable medium.

What is claimed is:

1. A method comprising:
joining a multicast group comprising program data;
discarding a first packet of program data received from the joined multicast group; and
comparing a sequence number of a second packet received from the joined multicast group and a sequence number of a third packet received from the joined multicast group; and
determining a sequence error in response to said comparison.

2. The method of claim 1, further comprising:
incrementing a packets received counter for each packet received from the joined multicast group; and
comparing each received sequence number with the next received sequence number.

3. The method of claim 2, further comprising:
adding multicast addresses of the joined multicast group to a multicast table.

4. The method of claim 3, wherein the tracking of sequence numbers and the packets received counter are associated with a multicast address of the multicast table.

5. The method of claim 3, wherein a multicast address of the multicast table has in correspondence a last received packet sequence number, a received packet count and a discard count.

6. The method of claim 3, further comprising:
removing one or more multicast addresses from the multicast table in the event that the one or more multicast addresses are not relevant to the joined groups.

7. The method of claim 1, further comprising:
incrementing an error counter in the event that there was a sequence error.

8. The method of claim 7, wherein the error counter tracks sequence errors across a plurality of joined multicast groups.

9. The method of claim 1, further comprising:
receiving a channel change request requesting a channel, the requested channel corresponding to the multicast group.

10. An apparatus comprising:
a processing unit for joining one or more multicast groups representing one or more data streams, discarding a predetermined number of received packets for each of the joined multicast groups; and comparing a sequence number of a first packet received subsequent to the predetermined number of discarded packets to a sequence number of a next subsequent received packet in order to determine a sequence error; and
a memory storing addresses of the joined one or more multicast groups and a sequence number of a last received packet.

11. The apparatus of claim 10 wherein said processing unit being further operative to:
increment a packets received counter for each packet received from the joined multicast group; and
compare each received sequence number with the next received sequence number.

12. The apparatus of claim 11 wherein said processing unit being further operative to:
add a multicast addresses of the joined multicast group to a multicast table.

13. The apparatus of claim 12, wherein the tracking of sequence numbers and the packets received counter are associated with a multicast address of the multicast table.

14. The apparatus of claim 12, wherein a multicast address of the multicast table has in correspondence a last received packet sequence number, a received packet count and a discard count.

15. The apparatus of claim 12 wherein said processing unit being further operative to:
remove one or more multicast addresses from the multicast table in the event that the one or more multicast addresses are not relevant to the joined groups.

16. The apparatus of claim 10 wherein said processing unit being further operative to:
increment an error counter in the event that there was a sequence error.

17. The apparatus of claim 16, wherein the error counter tracks sequence errors across a plurality of joined multicast groups.

18. The apparatus of claim 10 wherein said processing unit being further operative to:
receive a channel change request requesting a channel, the requested channel corresponding to the multicast group.
